(19) United States
(12) Patent Application Publication
(10) Pub. No.: US 2026/0211643 A1
(43) Pub. Date: Jul. 23, 2026

(54) CODE SUGGESTION SERVICE FOR APPLICATION CODE DEVELOPMENT IN DISTRIBUTED DEVELOPMENT ENVIRONMENTS

(71) Applicant: SAP SE, Walldorf (DE)

(72) Inventors: Manuel Berning, Dielheim (DE); Kai Patrick Reisert, Hemsbach (DE); Sevdiye Linnhoff, Heidelberg (DE); Cristina Buchholz, Reilingen (DE)

(21) Appl. No.: 19/035,034

(22) Filed: Jan. 23, 2025

(51) Int. Cl. G06F 8/36; G06F 8/35

(52) U.S. Cl. CPC G06F 8/36; G06F 8/35

(57) ABSTRACT

A computer-implemented system includes: a component of a local development environment generating a request to complete a source code and a code suggestion system. The request includes the context of the local development environment. The code suggestion system parses the context to define dependencies of code snippets of the source code under development. The code suggestion system determines corresponding databases including additional code objects associated to code objects of the source code under development identified by the dependencies of the source code. The code suggestion system retrieves the additional code objects and generates a prompt using a portion of the additional code objects. The prompt is formatted for minimizing a prompt size and provided to the prompt to a large language model to generate a response including a suggested code for completing the source code under development.

### TECHNICAL FIELD

The present disclosure relates to source code analysis. More particularly, implementations of the present disclosure are directed to generation of code suggestions for code development in distributed development environment.

### BACKGROUND

Software development issues increase with the complexity and size of the developed source code. Algorithms that assist software developers with code suggestions have been sought. Some of the algorithms that assist software code developers with code suggestions available are incompatible with a distributed development environment and thus hinder the effectiveness of their implementations. Algorithms which are compatible with the distributed development environment can still be rejected due to inherent limitations. For example, draft code generated by code suggestion tools is often rejected due to inaccuracy and irrelevance of the suggested code to the already existing code. Sophisticated algorithms that can analyze code patterns can generate suggestions that are accurate and relevant to subsequent code portions. Some of the developed sophisticated algorithms provide code suggestions with a notable delay or by generating interruptions that makes the usage of the code suggestion impractical.

### SUMMARY

Implementations of the present disclosure are directed to techniques and tools for source code analysis. More particularly, implementations of the present disclosure are directed to optimization of code suggestions for application development in distributed development environments.

In some implementations, a computer-implemented system, including: a component of a local development environment generating a request to complete a source code under development, the request including the context of the local development environment, and a code suggestion system coupled via an API, the code suggestion system parsing the context to generate a parsed context defining dependencies of code snippets of the source code under development, the code suggestion system processing the parsed context to determine corresponding databases including additional code objects associated to code objects of the source code under development identified by the dependencies of the source code, the code suggestion system retrieving, from the corresponding databases, the additional code objects associated to code objects of the source code under development, the code suggestion system generating a prompt using a portion of the additional code objects, the prompt being formatted for minimizing a prompt size, and the code suggestion system providing the prompt to a large language model to generate a response including a suggested code for completing the source code under development.

In a first aspect, combinable with the previous aspects, the code suggestion system parses the context to generate a parsed context by applying contextual understanding to determine a prefix and a suffix based on the context to query for a middle section to be filled. In another aspect, combinable with any of the previous aspects, the code suggestion system parses the context to generate a parsed context by: performing incremental parsing to reject a first portion of the code snippets including syntactically incorrect source code and to extract a second portion of the code snippets including syntactically correct source code, and extracting a portion of the context corresponding to the second portion of the code snippets including syntactically correct source code. In another aspect, combinable with any of the previous aspects, the code suggestion system parses the context to generate a parsed context to perform fill-in-the-middle tasks to fill in gaps between code snippets. In another aspect, combinable with any of the previous aspects, the code suggestion system parses the context to generate a parsed context by: determining a surrounding context of the source code within a source code development environment and dependencies influencing operations of the source code. In another aspect, combinable with any of the previous aspects, the code suggestion system retrieves, from the corresponding databases, the additional code objects associated to code objects of the source code under development by performing a plurality of retrieval operations for cascades of code object dependencies. In another aspect, combinable with any of the previous aspects, the additional code objects include inheritance related objects or interface related objects, compiler related objects, or externally defined object types, domain related objects. In another aspect, combinable with any of the previous aspects, the prompt is being formatted according to a large language model type.

In some implementations, a method includes: receiving, via an application programming interface from a local development environment, a request to complete a source code under development, the request including a context of the source code, parsing the context to generate a parsed context defining dependencies of code snippets of the source code under development, processing the parsed context to determine corresponding databases including additional code objects associated to code objects of the source code under development identified by the dependencies of the source code, retrieving, from the corresponding databases, the additional code objects associated to code objects of the source code under development, generating a prompt using a portion of the additional code objects, the prompt being formatted for minimizing a prompt size, and providing the prompt to a large language model to generate a response including a suggested code for completing the source code under development.

The foregoing and other implementations can each optionally include one or more of the following features, alone or in combination. In particular, implementations can include all of the following features:

In a first aspect, combinable with any of the previous aspects, parsing the context includes applying contextual understanding to determine a prefix and a suffix based on the context to query for a middle section to be filled. In another aspect, combinable with any of the previous aspects, parsing the context includes: performing incremental parsing to reject a first portion of the code snippets including syntactically incorrect source code and to extract a second portion of the code snippets including syntactically correct source code, and extracting a portion of the context corresponding to the second portion of the code snippets including syntactically correct source code. In another aspect, combinable with any of the previous aspects, parsing the context includes generating a parsed context to perform fill-in-the-middle tasks to fill in gaps between code snippets. In another aspect, combinable with any of the previous aspects, parsing the context includes: determining a surrounding context of the source code within a source code development environment and dependencies influencing operations of the source code. In another aspect, combinable with any of the previous aspects, retrieving, from the corresponding databases, the additional code objects includes performing a plurality of retrieval operations for cascades of code object dependencies. In another aspect, combinable with any of the previous aspects, the additional code objects include inheritance related objects or interface related objects, compiler related objects, or externally defined object types, domain related objects. In another aspect, combinable with any of the previous aspects, the prompt is being formatted according to a large language model type.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

These and other implementations can each optionally include one or more of the following advantages. The described approach advantageously provides an efficient automatic generation of code suggestions based on optimized prompts for large language models (LLMs). The generated code assistants are designed to enhance code development efficiency by offering accurate and relevant code suggestions, and even by generating entire code snippets, such as test cases. The described approach enhances the performance of code assistants by automatically refining prompts for LLMs to ensure that the prompts are both concise and rich in relevant information. The described prompt optimization leverages a highly integrated and coherent system that securely, holistically, and synergistically accesses multiple available information sources for retrieving relevant data. The extracted relevant data integrates the information corresponding to particular code types resulting in highly relevant code suggestions. The described implementations eliminate the implementation of duplicates since the context injection logic can be stored in a wrapper library or the server system, avoiding replication in both the wrapper library for training and on the system used during inference for code suggestions. The approach further reduces the computational overhead and latency associated with processing multiple models, while increasing the efficiency of the prompt optimization to provide code suggestions with improved accuracy.

It is appreciated that methods in accordance with the present disclosure can include any combination of the aspects and features described herein. That is, methods in accordance with the present disclosure are not limited to the combinations of aspects and features specifically described herein but also include any combination of the aspects and features provided.

The details of one or more implementations of the subject matter of the specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example system for generation of code suggestions, according to some implementations of the present disclosure.

FIG. 2 is a block diagram of an example system architecture for generation of code suggestions, according to some implementations of the present disclosure.

FIG. 3 is a flowchart of an example process for generation of code suggestions, according to some implementations of the present disclosure.

FIG. 4 is a block diagram of an exemplary computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

The present disclosure relates to generating software code suggestion using large language models (LLMs). More particularly, implementations of the present disclosure are directed to optimization of code assistants generating code suggestions for application development in distributed development environments. The code assistants include an application programming interface (API) of a development environment. The API provides a common interface for all local development environments to request code suggestions by sending a state of a respective local development environment indicative of a source code under development. The code assistants further include a code suggestion system coupled to the API. The code suggestion system parses a context provided by the integrated development environment, to generate a parsed context defining dependencies of code snippets of the source code under development. The code suggestion system processes the parsed context to determine corresponding databases including additional code objects associated to code objects of the source code under development identified by the dependencies of the source code. The code suggestion system retrieves, from the corresponding databases, the additional code objects associated to code objects of the source code under development. The code suggestion system generates a prompt using a portion of the additional code objects. The prompt is optimized to contain most relevant information given a prompt size supported by the LLM in use. The code suggestion system provides the prompt to an LLM to generate a response including a suggested code for completing the source code under development.

The use of LLMs to improve developer efficiency can be implemented by code assistants, which generate code, provide explanations for existing code, or suggest changes to code based on a state of a development environment. The state of the development environment can include the state of source code development artifacts present in the development environment, such as data models, attributes, relationships, categorizations of objects based on information from source code versioning systems, and data access strategies.

Most of newly developed source code development artifacts include data models that are built with core data services (CDS), an infrastructure used during software development to create an underlying data model for application services and to hide the complexity of database specifics and provided by SAP SE of Walldorf, Germany. The SAP Advanced Business Application Programming (ABAP) programming language provides a means to work with and integrate those declaratively defined service definitions and data models. CDS is integrated into SAPs ABAP programming language and offers features such as leveraging data dictionary semantics, consistent lifecycle management, and extensibility. Data models built with CDS include multiple code objects, such as CDS views, CDS entities, database tables, CDS tuning objects, or other artifacts. When developing an application including a CDS data model, most of the application dependencies are not replicated to a local development environment but reside in a central repository. All of the CDS artifact types are a source of further information that is integrated into the prompt. Further artifacts from other areas such as the SAP Data Dictionary (DDIC) or artifacts related to the RAP (Restful ABAP Programming) model. For RAP artifacts the most relevant artifact is for example the behavior definition (BDEF). While LLMs are designed to accurately summarize large amounts of text, traditional usage of LLMs is deficient in understanding prompt syntaxes requesting code suggestions and rules associated with SAP data and proprietary languages such as ABAP CDS and further dependent artifacts mentioned above, failing to consider the application dependencies due to the avoided local replication.

The described approach permits integration of dependencies (e.g., CDS or DDIC related) on shared code objects in a central repository and provides code suggestions in the respective local development environment. Addressing the limitations of LLM generated code suggestions, the generation of code snippets of the source code under development and retrieval of additional dependent code objects associated to the code snippets facilitate optimization of LLM prompts for code suggestions. The retrieval of additional dependent code objects described in the present disclosure is based on parsing the state of the distributed local development environments and selectively retrieving information from development artifacts stored in a central repository to add to the model prompt. The described approach of retrieving additional dependent code objects ensures that critical information impacting a code suggestion at a given cursor position is known to the LLM at inference. The described approach enhances the effectiveness and accuracy of code suggestions, optimizing the development of complex software systems in a distributed development landscape, where development code objects are shared between developers in a central repository.

The described approach provides an efficient automatic generation of LLM prompts for code suggestions based on an enriched representation of the state of the development environment. The described frontend sends a representation of the state of the development environment to the backend. The backend enriches the representation with additional information from the shared code objects in the central repository and formulates the prompt that is sent to the LLM. The described technical solution facilitates a multitude of possible integration possibilities with the parser, the compiler, the server-side code completion functionalities, and the inherent static code check tools, resulting in a superior quality in code suggestions. The described automatic generation of enriched and optimized LLM prompts for code suggestions eliminates the prerequisite for LLMs to learn to understand both source code and structural information provided in a separate format, reducing the computational overhead and latency associated with processing multiple models, while increasing the efficiency of the analysis with improved accuracy.

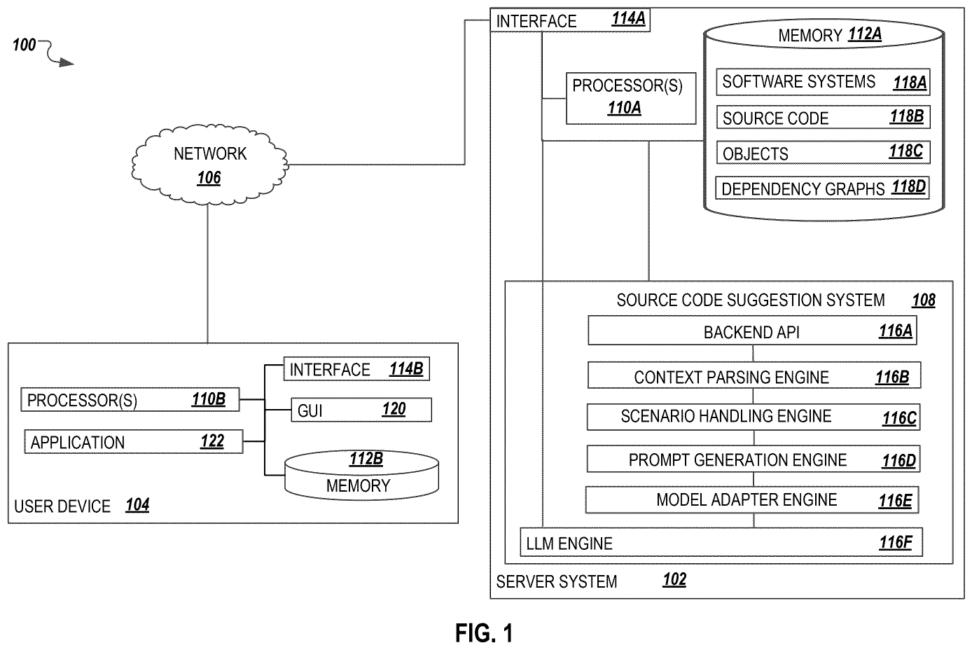

FIG. 1 is a block diagram of an example system 100 for generation of code suggestions, according to some implementations of the present disclosure. Specifically, the illustrated example system 100 includes or is communicably coupled with a server system 102, an end-user device 104, and a network 106. Although shown separately, in some implementations, functionality of two or more systems or servers can be provided by a single system or server. In some implementations, the functionality of one illustrated system, server, or component can be provided by multiple systems, servers, or components, respectively.

In the example of FIG. 1, the server system 102 is intended to represent various forms of servers including, but not limited to a web server, an application server, a proxy server, a network server, and/or a server pool for a distributed development environment (e.g., a cloud-based platform like the SAP Business Technology Platform (BTP) ABAP environment). In general, server systems 102 accept requests for application services including generation of code suggestions and provides such services to any number of end-user devices 104 (e.g., the user device 104 over the network 106). In accordance with implementations of the present disclosure, and as noted above, the server system 102 can host a solution environment that can be a cloud environment providing software applications, systems, and services that can be developed in multiple software development environments that share software code, collaborate on changes, and manage development processes in a distributed manner. In some instances, the server system 102 can support configuring of various tenants of different types, as well as services of different types that are integrated in customer integration scenarios and support execution of defined processes associated with generation of code suggestions. For example, the server system 102 includes a software code suggestion system 108, a processor 110A, a memory 112A, and an interface 114A.

The software code suggestion system 108 can include a backend API 116A, a context parsing engine 116B, a scenario handling engine 116C, a prompt generation engine 116D, a model adapter engine 116E, and a LLM engine 116F. The software code suggestion system 108 is coupled to the processor 110A, the memory 112A, and the interface 114A for generation of code suggestions using data stored in the memory 112A. The memory 112A can include software systems 118A, source code objects 118B, objects which do not have a source code representation such as data elements from the DDIC 118C, and dependency graphs 118D.

For example, user devices 104 that form software development environments generate requests for code suggestions for a given position in source code 118B under development compatible with the software system 118A. The software code suggestion system 108 can use the backend API 116A to request code suggestions by sending a state of the local development environment of a respective user device 104. The backend API 116A can service the code suggestion request from different integrated development environments and transmit the service request to the context parsing engine 116B. The context parsing engine 116B parses the context provided by the local development environment to generate a parsed context including information extracted about the state of the local development environment such as open tabs, untransmitted code changes also in other source code artifacts, or documentation opened. The scenario handling engine 116C can analyze the parsed context to identify, which scenario the code suggestion request represents, e.g. code suggestion for the implementation of a method body or code suggestion for adding a code snippet to the public section of a class. The scenario can be used to decide additional resources to query. The prompt generation engine 116D fetches the additional information from the identified additional resources in the memory 112A and decides which information to include in the prompt sent to the model. The prompt generation engine 116D can send the enriched prompt to the model adapter engine 116E for further processing. The model adapter engine 116E can format, using vector descriptions, contexts, and a prompt template, in order to format the prompt for the LLM engine 116F.

The LLM engine 116F can generate code suggestions and textual descriptions of the code suggestions associated with the code under development at the user device 104. The LLM engine 116F can be deployed as an API, facilitating integration into the development environment of the user device 104. The API deployment of the LLM engine 116F facilitates access to code suggestions in real-time. The software code suggestion system 108 can transmit the code suggestions and textual descriptions of the code suggestions to be displayed on the graphical user interface (GUI) 120 of the user device 104. For example, the software code suggestion system 108 of the present disclosure is coupled to the interface 114A to provide an integrated user interface (UI) rendering solution within a digital assistant that leverages generative LLM to infer code suggestions compatible with the software system 118A and optimize prompt display of the code suggestions for an efficient development of the software source code 118B. More particularly, the software code suggestion system 108 of the present disclosure calls the prompt generation engine 116D to leverage the ability of the prediction engines including LLM 116F to generate optimized code suggestions using an enriched prompt.

In general, the end-user device 104 includes an electronic computer device operable to receive, transmit, process, and store any appropriate data associated with the system 100 of FIG. 1. The end-user device 104 is intended to encompass any client computing device such as a laptop/notebook computer, wireless data port, smart phone, personal data assistant (PDA), tablet computing device, one or more processors within these devices, or any other suitable processing device. The end-user device 104 includes an interface 114B, a processor 110B, a memory 112B, and a GUIs 120. The end-user device 104 can include one or more applications 122. The application 122 can be any type of application including an application that allows a user device to develop software source code 118B with shared code objects 118C in the memory 112A serving as a central repository. The application 122 of the end-user device 104 can automatically request code suggestions during development of the software source code 118B. In some implementations, an application 122 can use parameters, metadata, and other data to access the software code suggestion system 108 from the server system 102.

In accordance with implementations of the present disclosure, the application 122 includes a digital assistant that enables interactions with the user device 104. For example, and as described in further detail herein, the digital assistant of the user device 104 can receive software code suggestions. In some examples, one or more software code suggestions can include software code snippets and/or code entities that are presented as a graphical representation in the GUI 120. In accordance with implementations of the present disclosure, the GUI 120 can present software code suggestions as a graphical representation in a popover container within a software development window. In some examples, the graphical representation can be provided as a web-based rendering using a web rendering runtime that is built into the popover container (e.g., iframe). In some examples, the graphical representation is compatible with a UI framework of the popover container. An example UI framework includes, without limitation, SAP's SAPUI5.

In some implementations, any, or all, of the components of the example system 100, both hardware or software (or a combination of hardware and software), can interface with each other or the interface(s) 114A, 114B (or a combination of both) over the network 106 for generation of code suggestions. The functionality of the end-user device 104 can be accessible for all service consumers using the application 122 that transmits prompts to the software code suggestion system 108 to generate code suggestions.

For example, the end-user device 104 can include a computer that includes an input device, such as a keypad, touch screen, or other device that can accept user information, and an output device that conveys information associated with the operation of the server system 102, or the user device itself, including digital data, visual information, or a GUI 120, respectively. The GUI 120 each interface with at least a portion of the system 100 for any suitable purpose, including generating a visual representation of the application 122. The GUI 120 can provide the user with an efficient and user-friendly presentation of code suggestions provided by or communicated within the system. The GUI 120 can include a plurality of customizable frames or views having interactive fields, pull-down lists, and buttons operated by the user. The GUI 120 can include any suitable graphical user interface, such as a combination of a generic web browser, intelligent engine, and command line interface (CLI) that processes information and efficiently presents the code suggestions to the user visually. The GUI 120 can present the code suggestions as ghost text (e.g., grayed out text, or text displayed using light color fonts) inside the integrated development environment application (e.g., ABAP Developer Tools) while the user is typing source code using traditional coding tools.

In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems. Data exchanged over the network 106, is transferred using any number of network layer protocols, such as Internet Protocol (IP), Multiprotocol Label Switching (MPLS), Asynchronous Transfer Mode (ATM), Frame Relay, etc. Furthermore, in implementations where the network 106 represents a combination of multiple sub-networks, different network layer protocols are used at each of the underlying sub-networks. In some implementations, the network 106 represents one or more interconnected internetworks, such as the public Internet.

Each processor 110A, 110B included in the end-user device 104 can be a central processing unit (CPU), an application specific integrated circuit (ASIC), a field-programmable gate array (FPGA), or another suitable component. Each processor 110A, 110B included in the end-user device 104 executes instructions and manipulates data to perform the operations of the end-user device 104, respectively. In particular, each processor 110A, 110B included in the end-user device 104 executes the functionality required to send requests to the server system 102 and to receive and process responses from the server system 102. Each processor 110A, 110B executes instructions and manipulates data to perform the operations of the respective system (the server system 102, the end-user device 104). Specifically, each processor 110A, 110B executes the functionality required to receive and respond to requests from the respective system (the server system 102, the end-user device 104), for example.

Interfaces 114A, 114B are used by the server system 102, the end-user device 104, respectively, for communicating with other systems in a distributed environment—including within the system 100—connected to the network 106. The interfaces 114A, 114B each include logic encoded in software and/or hardware in a suitable combination and operable to communicate with the network 106. More specifically, the interfaces 114A, 114B can each include software supporting one or more communication protocols associated with communications such that the network 106 or interface's hardware is operable to communicate physical signals within and outside of the illustrated system 100.

The memory 112A, 112B can include any type of memory or database module and can take the form of volatile and/or non-volatile memory including, without limitation, magnetic media, optical media, random access memory (RAM), read-only memory (ROM), removable media, or any other suitable local or remote memory component. The memory 112A, 112B can store various code objects or data, including caches, classes, frameworks, applications, backup data, code objects, jobs, web pages, web page templates, database tables, database queries, repositories storing static and/or dynamic information, and any other appropriate information including any parameters, variables, algorithms, instructions, rules, constraints, or references thereto associated with the purposes of the server system 102, or the end-user device 104, respectively.

There can be any number of end-user devices 104 and server systems 102 associated with, or external to, the system 100, forming a distributed development environment where software code is developed at remotely located end-user devices 104. Additionally, the example system 100 can include one or more additional user devices external to the illustrated portion of system 100 that are capable of interacting with the system 100 using the network(s) 106. Further, the term “client,” “user device,” and “user” can be used interchangeably as appropriate without departing from the scope of the disclosure. Moreover, while user device can be described in terms of being used by a single user, the disclosure contemplates that many users can use one computer, or that one user can use multiple computers. As used in the present disclosure, the term “computer” is intended to encompass any suitable processing device. For example, although FIG. 1 illustrates a single server system 102, a single end-user device 104, the system 100 can be implemented using a single, stand-alone computing device, two or more servers 102, or multiple user devices. The server system 102, and the end-user device 104 can include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server system 102 and the end-user device 104 can be adapted to execute any operating system or runtime environment, including Linux, UNIX, Windows, Mac OS®, Java™, Android™, iOS, BSD (Berkeley Software Distribution) or any other suitable operating system. According to one implementation, the server system 102 can also include or be communicably coupled with an e-mail server, a Web server, a caching server, a streaming data server, and/or another suitable server.

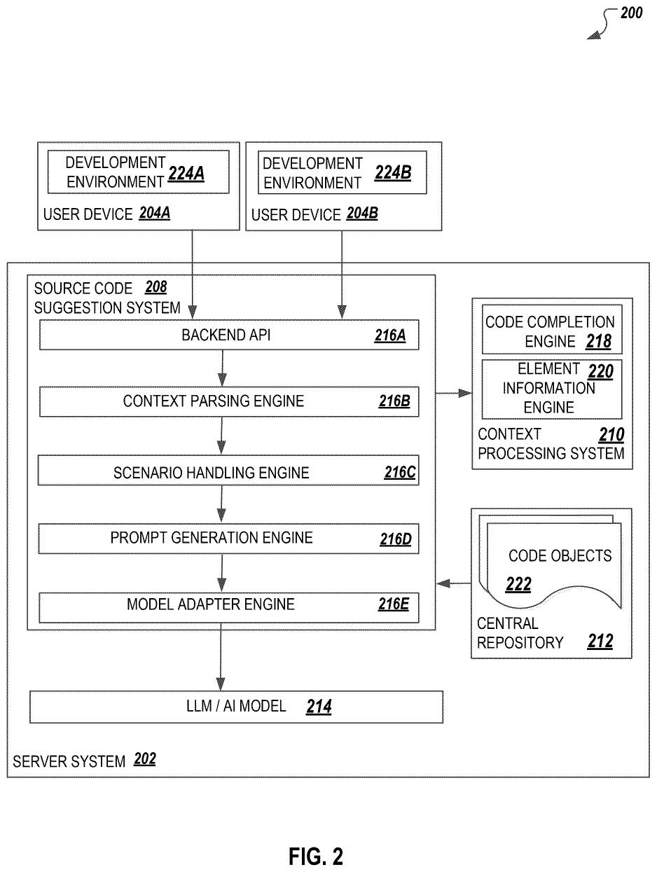

Regardless of the particular implementation, “software” can include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language including C, C++, Java™, JavaScript®, Visual Basic, assembler, Perl®, ABAP, ABAP OO (Object Oriented), any suitable version of a fourth-generation programming language (4GL), as well as others. While portions of the software illustrated in FIG. 1 are shown as individual modules that implement the various features and functionality through various code objects, methods, or other processes, the software can instead include multiple sub-modules, third-party services, components, libraries, and such, as appropriate. Conversely, the features and functionality of various components can be combined into single components as appropriate. The communication between the end user device 104 and the server system 102 can include several different communication protocols configured to optimize generation of code suggestions, as further described in detail with reference to FIGS. 2-4.

FIG. 2 is a block diagram of an example system architecture 200 for generation of code suggestions, according to some implementations of the present disclosure. The example system architecture 200 includes a server system 202 (e.g., server system 102 described with reference to FIG. 1) and user devices 204A, 204B (e.g., user device 104 described with reference to FIG. 1).

The server system 202 includes a software code suggestion system 208 (e.g., software code suggestion system 108 described with reference to FIG. 1), a context processing system 210, a central repository 212 (e.g., memory 112A described with reference to FIG. 1), and a LLM model 210 (e.g., LLM engine 116F described with reference to FIG. 1). The software code suggestion system 108 can include a backend API 216A, a context parsing engine 216B, a scenario handling engine 216C, a prompt generation engine 216D, and a model adapter engine 216E. The context processing system 210 includes the code completion engine 218 and an element information engine 220. The code completion in the backend described herein is sometimes called “classical code completion” to disambiguate from the AI based code completion tool, which can usually only generate a list of possible word to insert at the cursor position based on syntax and deterministic/classical algorithms. The code completion in the backend described herein provides significant assistance, when predicting larger code snippets using AI when added to the prompt. The element information can yield information about any identifier in the code (e.g., variable, database table name, CDS view name, DDIC data element, RAP BDEF) that is critical in providing accurate and compatible suggestions.

The central repository 212 can store shared source code objects 222.

The user devices 204A, 204B generate source code files within the development environments 224A, 224B. The source code files can include new source code files generated for the software systems (e.g., software systems 118A described with reference to FIG. 1) including dependencies (e.g., cascades of dependencies like inheritance hierarchies or chain of interface implementations) on source code objects 222. The source code files include portions of a software source code under development including one or more completed code segments and missing one or more intended code segments planned to be added. The completed code segments can include parts of the code that have been fully developed, tested, and are functioning as intended.

The completed code segments can include functions, classes, or modules that perform particular tasks within the software. The completed code segments can include defined dependencies on source code objects 222 stored in the central repository 212. The dependent code objects 222 can for example include code objects related through inheritance or interfaces, additional dependencies the compiler uses, external type definitions, domains, database views as well as an application context, such as natural language description of code requests or requirements, and developed object dependencies on particular queries and data.

The incomplete code segments can include placeholders or partially written code that indicate where additional functionality is planned to be added. The incomplete code segments can include comments indicating planned integration of dependencies on source code objects 222 stored in the central repository 212. The comments indicating planned integration of dependencies on source code objects 222 can include a natural language description of planned code requests or requirements. The source code files include comments describing the source code file, the completed code segments and the intended code segments planned to be added. Comments can be included within the code to explain the purpose of particular sections, outline the logic, or provide instructions for future development. The incomplete code segments can include comments or notes explaining what is planned to be implemented for source code completion. New source code files can be entirely new additions to the software systems, being stored in the memory, representing new features or components being integrated into the existing codebase. The source code files can be organized in a way that reflects the overall architecture of the software, with clear separation between different components and logical groupings of related code to facilitate software development in the distributed development environment by indicating what has been completed and what is planned to be developed and added to the source code.

The backend API 216A of the software code suggestion system 208 facilitates secure access to a frontend API, verifying the identity of the requesting environment development environments 224A, 224B. The backend API 216A provides a common interface for the local development environments 224A, 224B to request code suggestions during software code development on the user devices 204A, 204B. The backend API 216A can collect the current state of the local development environments 224A, 224B, including open files, cursor position, and recent edits. The backend API 216A gathers semantic information including a project structure, dependencies, and configuration files corresponding to the current state of the local development environments 224A, 224B. The backend API 216A loads the data along with semantic information to the context parsing engine 216B. The semantic information retrieved, by the inference engine 204, from the memory 210A describes the identifiers, types, database tables, references, and relationships between the code objects in the source code of an application, as well as global system objects, such as system classes or database tables. The backend API 216A transmit the service request to the context parsing engine 216B.

The context parsing engine 216B analyzes and parses the context of the local development environment 224A, 224B provided by the backend API 216A to generate a parsed context including information extracted to improve the LLM prompt. The context parsing engine 216B analyzes the context by performing a syntax and semantics analysis. The context parsing engine 216B analyzes the state of the user device application transmitted via the API and uses syntax and semantics of the code to determine the code structure and intention of the current codebase. The context parsing engine 216B analyzes the context by performing an internal dependency analysis. The context parsing engine 216B examines dependencies and relationships between different parts of the code to provide a comprehensive understanding of the project. The context parsing engine 216B parses the context to convert the extracted information into a scenario including a structured processable format that can be processed by the scenario handling engine 216C.

The scenario handling engine 216C can analyze the scenarios including the parsed context to identify a scenario type and determine additional resources corresponding to the scenario type that can be queried to retrieve relevant information. The scenario types include for example a generic request for a code suggestion, a request for a method implementation, a request for a method definition, a request for a function usage implementation or a request for an action, determination, or validation of a business object. For requests related to method implementation, the scenario handling engine 216C retrieves relevant code snippets, best practices, and documentation to assist in writing the method. For method definitions, the scenario handling engine 216C retrieves templates, parameter type suggestions, and examples based on the project's coding standards. For function usage implementation scenarios, the scenario handling engine 216C retrieves code examples, optimization tips, and relevant library functions. For actions, determinations or validations, the scenario handling engine 216C retrieves the behavior definition for the object, general validation rules, error handling practices, and similar patterns already within the codebase.

The prompt generation engine 216D fetches the additional information from the identified additional resources in the memory 212A. The prompt generation engine 216D processes and filters the retrieved information to generate filtered information to be included in the prompt sent to the LLM 214. The prompt generation engine 216D can filter the retrieved information according to the identified scenario type. The prompt generation engine 216D can generate, using the scenario type, the filtered additional information, and a prompt for the LLM 214. For example, for each query corresponding to a scenario type, a prompt having a particular format defined by a prompt template is generated, by the prompt generation engine 216D. The prompt generation engine 216D can generate the prompt including a prefix, a middle and a suffix. The prompt generation engine 216D can optimize the prompt by creating a ranked list of pieces of information from the filtered additional information. The inherent ranking of the filtered additional information facilitates the prioritization of the most relevant information. The prompt generation engine 216D can optimize the prompt by filling up a context window. For example, the ranked list of information is used to fill the context window. The ranked information is added to the context in order of priority until the context window is full.

The model adapter engine 216E can format, using guidelines of a target LLM, a formatted prompt for the LLM 214. In some implementations, the guidelines are tested for different LLMs based on performance measurements. The test results are used to generate a relationship between guidelines for prompt formats and target LLMs. The prompt generation engine 216D can include a generator, which can generate context in a common structural format such as JavaScript Object Notation (JSON) or extensible markup language (XML).

The LLM 214 can process the prompt formatted according to respective guidelines and additional input data (e.g., context data) to generate source code suggestions. The generated source code suggestions include textual descriptions of code entities formatted according to a programming language associated with the language used in the source code file. The LLM 214 can send the source code suggestions to the respective user device 204A, 204B that generate the code suggestion request. The LLMs can include GPT 35 TURBO, GPT 35 TURBO-16K, GPT-4, or GPT-4-32K, STARCODER, STARCODER2, (CODE) LLAMA, MISTRAL, MINISTRAL, CODESTRAL, or (ANTHROPIC) CLAUDE.

The LLM 214 can be trainable on vast quantities of code entities (e.g., thousands of classes). The training of the LLM 214 can include contextual training, the prompt generation engine 216D providing clear context for the code suggestions. The training of the LLM 214 exposes the LLM 214 to enriched contexts during training, facilitating the LLM 214 to learn to work with more comprehensive prompts. The training of the LLM 214 trains the LLM 214 to understand that prompts can include more information than just the immediate snippets, improving the ability of the LLM 214 to generate responses based on richer contexts. In some implementations, instead of training LLM 214 to generate complete responses from scratch, the LLM 214 is trained by a training engine to fill in the middle of a given context. The fill in the middle approach assists the training engine to efficiently integrate additional information into responses, making the LLM 214 more versatile and effective in handling complex prompts.

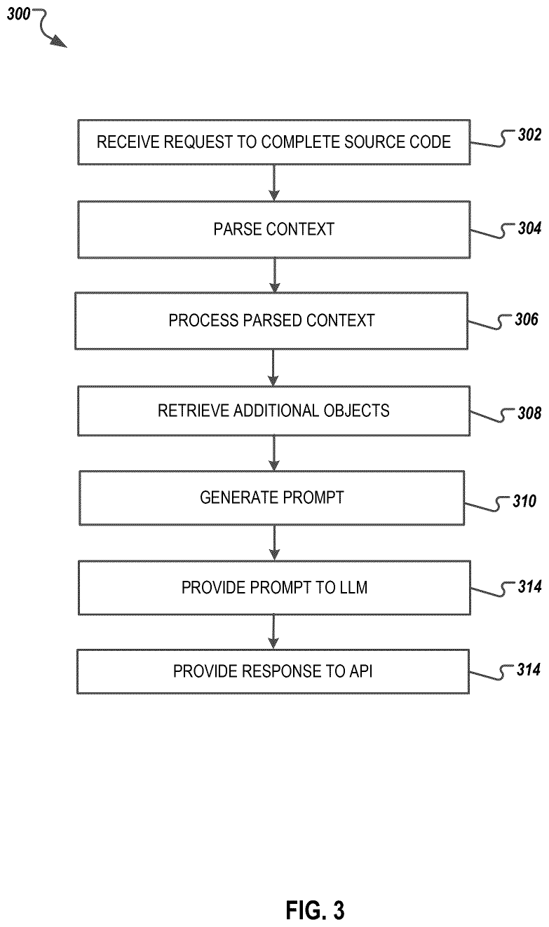

For example, a prompt can include comments or descriptions that specify a target functionality or constraints. The training of the LLM 214 can use the context windows to provide the LLM 214 with sufficient information about a portion of the code surrounding a cursor within the source code under development. The LLM 214 uses the context windows to generate code suggestions that are coherent and contextually appropriate for the source code under development. In some implementations, the source code suggestion system 208 can include a post-processor that mitigates a risk of LLM hallucinations and to improve formatting of the response from the LLM (e.g., based on a format chosen in a communication schema) and returns the answer to the end user device 204A, 204B. Current LLMs are usually much more sensitive to information included in the beginning (prefix) or in end (suffix) of the prompt. Including the cursor context in the prefix or the suffix of the prompt can increase the accuracy of the code suggestions generated by the LLM 214. The source code suggestion system 208 transmits the generated code suggestions to the user device 204A, 204B for real-time display within the development environment 224A, 224B. Further details regarding the design and operation of the software code suggestion system 214 are described in concurrently filed patent application ______, filed on ______, by SAP SE, which is hereby incorporated by reference in its entirety. Further details regarding the generation of code suggestions, executed by the software code suggestion system 208, are provided with reference to FIG. 3.

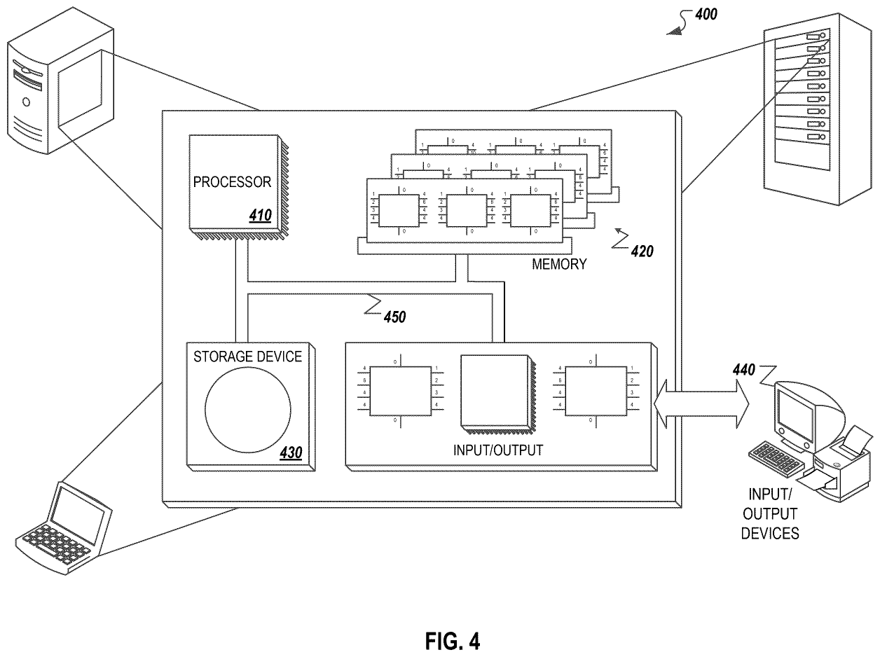

FIG. 3 is a flowchart of an example process 300 for generation of code suggestions, according to some implementations of the present disclosure. The example process 300 can be performed by any component of the example system 100, described with reference to FIG. 1 or the example system architecture 200, described with reference to FIG. 2 or the example computing system 400, described with reference to FIG. 4. For clarity of presentation, the description that follows describes the example process 300 in the context of the systems described with reference to FIGS. 1, 2, and 4.

At 302, a request to complete a portion of a source code under development is received, by one or more processors. In some implementations, the request of the source code suggestion includes a representation of the state of the local development environment to allow parsing of the local context including the source code. The source code can include software products (e.g., multiple open-source software (OSS) components which are built by independent software product providers). The source code includes code snippets (e.g., small, reusable pieces of code that can be inserted into larger programs) and one or more code entities (e.g., complex and structured components of a codebase), such as classes, methods, variables, and database tables. The portion of a source code under development can include a segment of the source code within a set window (defined based on a number of code snippets) from a cursor. The state of the development environment including the source code can be sent to the backend API in real time.

At 304, a context of the state of the development environment is parsed, by the one or more processors, to generate a parsed context. Parsing the context to generate a parsed context includes applying contextual understanding to determine a current state of the development environment, which includes open files, cursor positions, recent edits of code snippets, and project-specific configurations. The current state of the development environment is used to determine a beginning (prefix) and an end (suffix) of the relevant context to query for a middle section to be added by the LLM. Parsing the context to generate a parsed context includes performing incremental parsing to filter out any syntactically incorrect code snippets. The identification and removal of code snippets ensures that only valid code is considered for further processing. Parsing the context to generate a parsed context includes determining the surrounding context of the source code, which includes the development environment settings, dependencies, and other influencing factors for performing fill-in-the-middle tasks to fill in gaps between the code snippets. Parsing the context to generate a parsed context includes determining a surrounding context of the source code that define a source code development environment and dependencies influencing operations of the source code. The analysis of the dependencies that affect the operations of the source code, ensures that the generated suggestions are compatible with the existing project setup.

At 306, the parsed context is processed, by the one or more processors, to determine corresponding databases including additional code objects associated to code objects of the source code under development identified by the dependencies of the source code. The additional code objects include inheritance related objects or interface related objects, compiler related objects, or externally defined object types, domain related objects.

At 308, additional code objects associated to code objects of the source code under development are retrieved from additional resources by one or more processors. Retrieving, from the corresponding databases, the additional code objects associated to code objects of the source code under development includes performing a plurality of retrieval operations for cascades of code object dependencies.

In some implementations, a dependency graph is generated, by the one or more processors, using a dependency graph engine that parses the additional code objects and, along with their dependencies, constructs the graph by extracting each code entity accordingly. The dependency graph exposes relations and dependencies between the code entities. Each node of the dependency graph represents a code entity (code snippet), while each edge represents a dependency between two code entities. The dependency graph can include a multi-directional including mutual dependencies between nodes. A portion of the code entities of the dependency graph is filtered, by one or more processors, to reduce the size of the dependency graph. The filtering process can include identifying and removing nodes of the dependency graph that represent unused code entities. The unused code entities can be code snippets, such as functions, classes, or variables that are defined but never called or referenced within the developed source code. The filtering process can include removal of edges that represent redundant or unnecessary dependencies. For example, if a dependency is only used in a test environment, it can be considered irrelevant for the main application. The filtering process can include application of ranking (based on a relevance to a query code entity) or any custom rules particular to the project or domain. For example, deprecated code entities or dependencies that are marked for removal can be filtered out. Filtering can include extraction of dependencies for the current code suggestion request that can become too large for the context window of the LLM.

In some implementations, the dependency graph is minimized by using the filtered and ranked list of code snippets or code entities and a context of the query code entity for generating a minimized dependency graph. Minimizing the dependency graph includes traversing the dependency graph beginning with the node of the query entity and iteratively estimating the required budget of an entity and adding the most relevant ones, which fit the remaining budget to the context until the token limit is reached. Minimizing the dependency graph includes selection of the most relevant parts of the context, relative to the token limit of the currently used LLM. It is determined, by the one or more processors, whether the minimized dependency graph is within limits to ensure, that the token limits of the LLM are not exceeded, while still providing the most relevant context information. In response to determining, by the one or more processors, that the minimized dependency graph exceeds the limits, the dependency graph can be further minimized until determining, by the one or more processors, that the minimized dependency graph is within limits.

At 310, a prompt is generated, by the one or more processors, using a portion of the additional code objects. For example, the prompt can be generated by converting the minimized dependency graph into a prompt format processable by a large language model to generate matching code for the source code under development. The prompt can be generated into a format that can be used by the large language model, such as JSON or actual code, using the minimized dependency graph and a prompt template. In some implementations, the prompt includes as a prefix or as a suffix a portion of the source code proximal to the cursor to facilitate generation of relevant code suggestions relative to a cursor position within the source code under development. The prompt can include a request to generate a matching code for the source code under development according to a source code context and cursor context. In some implementations, the prompt is validated, by the processor, by processing the one or more requirements. Validation of the prompt by processing the one or more textual includes a verification of context requirements according to fields of the prompt template. The validation can be executed according to one or more conditions defining a minimum number of textual requirements to be included to enable processing of the request, such as inclusion in the request of at least a use-case for the requested code suggestion, a minimum number of rows within the cursor context, context inclusion, and at least one target platform or system. In some implementations, in response to determining that the prompt is missing at least one textual requirement, the process returns to receiving source code.

At 312, the prompt is provided to the LLM to generate source code suggestions. The LLM can process the prompt including the additional input data (e.g., context data) to produce source code suggestions (code entities formatted according to a programming language associated with the language used in the source code file). The LLM uses the context window to generate code suggestions that are coherent and contextually appropriate for the source code under development. The LLM can be trainable on vast quantities of code entities (e.g., thousands of classes). The training of the LLM can include contextual training. The training of the LLM can use the context window to provide the LLM with enough information about a portion of the code surrounding a cursor within the source code under development. The training of the LLM can be aligned with inferring the semantic information from an application repository. In some implementations, the LLM can automatically apply a threat analysis to the developed source code and adjust the source code suggestions to minimize security threat vulnerabilities.

At 314, the source code suggestions are transmitted to the user device where the source code is under development to be displayed in real time. In some implementations, the source code can be updated, by the one or more processors, to include additional source code suggestions. For example, if a vulnerability of the source code under development is detected, the source code suggestions can be automatically included in the source code to minimize its vulnerability. The automatically added source code suggestions can include an adjustment of data flow according to a secure sequence of data transmission between the system nodes. The data flow can be defined by templates indicating which components can be added. The templates can correspond to particular security communication scenarios. An application invoking a sequence of the adjusted data flow can be executed. The execution of the data flow can include retrieval of one or more APIs from a database. The execution of the application can include generating an artifact matching the sequence of APIs. The execution of the application can include code generation for connection to the selected APIs to generate the data flow. The source code suggestions and, if applicable, the output of the automatically embed API calls in source code can be displayed by a graphical user interface of the user device.

The example process 300 for generation of code suggestions provides an advantage of parsing the context of the local development environment to extract all dependencies and resolves the dependencies by querying the central repository. The example process 300 additionally advantageously uses backend services, which can provide additional knowledge about the code close to the cursor position including context information. As another advantage, the example process 300 is able to efficiently select most relevant context based on the relevance of the code entities to the query code entity and the current LLM use-case. In contrast to a “one-shot-fits-all” approach, where the context is always based on the current open development tabs, the context selection of the example process 300 facilitates efficient context injection pipelines for each use-case. The described context selection can be tailored to the respective LLM requirements by using different ranking models and can filter code entities differently between LLM use-cases, increasing the accuracy of the code suggestions generated by the respective LLM. As another advantage, the example process 300 provides a deterministic code completion solution and a service providing information about identifiers used in the code. The usage of other backend services can also be used in postprocessing the response from the LLM to correct syntax errors to improve performance of the generated code. The LLM chooses the most probable code suggestion by applying particular logic based on the information provided by the central repository and the additional backend services.

As another advantage, the example process 300 incorporates a code generation, which converts each code-entity into a “fake” code-snippet, which seamlessly blends into the original code snippet. The code generation also applies to form-based definitions that do not actually have a code equivalent. The code generation allows the example process 300 to express context information independent of code fragmentation and programming paradigms. The example process 300 also removes the necessity of the LLM to learn to understand both source code and structural information provided in a separate format. The example process 300 can include a generator which can generate context in a common structural format such as JSON or XML. The example process 300 also provides an efficient way to analyze code entities for a source code under development to determine if a given code entity is associated to any security issues that require a quick response to preserve system security. The example process 300 can be executed as a time-sensitive operation, to provide ample time to update the software package and to minimize a risk of a malicious attack of vulnerable software source code components under development in the distributed development environments.

FIG. 4 is a block diagram of an example computing system 400 used to provide computational functionalities associated with described algorithms, methods, functions, processes, flows, and procedures, according to some implementations of the present disclosure. As shown in FIG. 4, the computing system 400 can include a processor 410, a memory 420, a storage device 430, and input/output devices 440. The processor 410, the memory 420, the storage device 430, and the input/output devices 440 can be interconnected using a system bus 450. The processor 410 is capable of processing instructions for execution within the computing system 400. Such executed instructions can implement one or more components of, for example, the software code suggestion system 108, described with reference to FIG. 1. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided using the input/output device 440.

The memory 420 is a computer readable medium such as volatile or non-volatile that stores information within the computing system 400. The memory 420 can store data structures representing configuration object databases, for example. The storage device 430 can provide persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a LAN, a WAN, the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided using the input/output device 440. The user interface can be generated and presented to a user by the computing system 400 (e.g., on a computer screen monitor).

One or more aspects or features of the subject matter described herein can be realized in digital electronic circuitry, integrated circuitry, specially designed ASICs, FPGAs computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) can contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes can take place simultaneously, concurrently, in parallel, and/or in different orders than as shown. Moreover, processes can have additional operations, fewer operations, and/or different operations, so long as the methods remain appropriate.

In other words, although the disclosure has been described in terms of certain implementations and associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented system, comprising: a component of a local development environment generating a request to complete a source code under development, the request comprising the context of the local development environment; and a code suggestion system coupled via an API, the code suggestion system parsing the context to generate a parsed context defining dependencies of code snippets of the source code under development, the code suggestion system processing the parsed context to determine corresponding databases comprising additional code objects associated to code objects of the source code under development identified by the dependencies of the source code, the code suggestion system retrieving, from the corresponding databases, the additional code objects associated to code objects of the source code under development, the code suggestion system generating a prompt using a portion of the additional code objects, the prompt being formatted for minimizing a prompt size, and the code suggestion system providing the prompt to a large language model to generate a response comprising a suggested code for completing the source code under development.

Example 2. The computer-implemented system of the preceding example, wherein the code suggestion system parses the context to generate a parsed context by applying contextual understanding to determine to determine a prefix and a suffix based on the context to query for a middle section to be filled.

Example 3. The computer-implemented system of any of the preceding examples, wherein the code suggestion system parses the context to generate a parsed context by: performing incremental parsing to reject a first portion of the code snippets comprising syntactically incorrect source code and to extract a second portion of the code snippets comprising syntactically correct source code; and extracting a portion of the context corresponding to the second portion of the code snippets comprising syntactically correct source code.

Example 4. The computer-implemented system of any of the preceding examples, wherein the code suggestion system parses the context to generate a parsed context to perform fill-in-the-middle tasks to fill in gaps between code snippets.

Example 5. The computer-implemented system of any of the preceding examples, wherein the code suggestion system parses the context to generate a parsed context by: determining a surrounding context of the source code within a source code development environment and dependencies influencing operations of the source code.

Example 6. The computer-implemented system of any of the preceding examples, wherein the code suggestion system retrieves, from the corresponding databases, the additional code objects associated to code objects of the source code under development by performing a plurality of retrieval operations for cascades of code object dependencies.

Example 7. The computer-implemented system of any of the preceding examples, wherein the additional code objects comprise inheritance related objects or interface related objects, compiler related objects, or externally defined object types, domain related objects.

Example 8. The computer-implemented system of any of the preceding examples, wherein the prompt is being formatted according to a large language model type.

Example 9. A computer-implemented method, comprising: receiving, via an application programming interface from a local development environment, a request to complete a source code under development, the request including a context of the source code; parsing the context to generate a parsed context defining dependencies of code snippets of the source code under development; processing the parsed context to determine corresponding databases comprising additional code objects associated to code objects of the source code under development identified by the dependencies of the source code; retrieving, from the corresponding databases, the additional code objects associated to code objects of the source code under development; generating a prompt using a portion of the additional code objects, the prompt being formatted for minimizing a prompt size; and providing the prompt to a large language model to generate a response comprising a suggested code for completing the source code under development.

Example 10. The computer-implemented method of the preceding example, wherein parsing the context comprises applying contextual understanding to determine to determine a prefix and a suffix based on the context to query for a middle section to be filled.

Example 11. The computer-implemented method of any of the preceding examples, wherein parsing the context comprises: performing incremental parsing to reject a first portion of the code snippets comprising syntactically incorrect source code and to extract a second portion of the code snippets comprising syntactically correct source code; and extracting a portion of the context corresponding to the second portion of the code snippets comprising syntactically correct source code.

Example 12. The computer-implemented method of any of the preceding examples, wherein parsing the context comprises generating a parsed context to perform fill-in-the-middle tasks to fill in gaps between code snippets.

Example 13. The computer-implemented method of any of the preceding examples, wherein parsing the context comprises: determining a surrounding context of the source code within a source code development environment and dependencies influencing operations of the source code.

Example 14. The computer-implemented method of any of the preceding examples, wherein retrieving, from the corresponding databases, the additional code objects comprises performing a plurality of retrieval operations for cascades of code object dependencies.

Example 15. The computer-implemented method of any of the preceding examples, wherein the additional code objects comprise inheritance related objects or interface related objects, compiler related objects, or externally defined object types, domain related objects.

Example 16. The computer-implemented method of any of the preceding examples, wherein the prompt is being formatted according to a large language model type.

Example 17. A non-transitory computer-readable media encoded with a computer program, the computer program comprising instructions that when executed by one or more computers cause the one or more computers to perform operations comprising: receiving, via an application programming interface from a local development environment, a request to complete a source code under development, the request including a context of the source code; parsing the context to generate a parsed context defining dependencies of code snippets of the source code under development; processing the parsed context to determine corresponding databases comprising additional code objects associated to code objects of the source code under development identified by the dependencies of the source code; retrieving, from the corresponding databases, the additional code objects associated to code objects of the source code under development; generating a prompt using a portion of the additional code objects, the prompt being formatted for minimizing a prompt size; and providing the prompt to a large language model to generate a response comprising a suggested code for completing the source code under development.

Example 18. The non-transitory computer-readable media of the preceding example, wherein parsing the context comprises applying contextual understanding to determine to determine a prefix and a suffix based on the context to query for a middle section to be filled.

Example 19. The non-transitory computer-readable media of any of the preceding examples, wherein parsing the context comprises: performing incremental parsing to reject a first portion of the code snippets comprising syntactically incorrect source code and to extract a second portion of the code snippets comprising syntactically correct source code; and extracting a portion of the context corresponding to the second portion of the code snippets comprising syntactically correct source code.

Example 20. The non-transitory computer-readable media of any of the preceding examples, wherein parsing the context comprises generating a parsed context to perform fill-in-the-middle tasks to fill in gaps between code snippets.

What is claimed is:

1. A computer-implemented system, comprising:
a component of a local development environment generating a request to complete a source code under development, the request comprising the context of the local development environment; and
a code suggestion system coupled via an API, the code suggestion system parsing the context to generate a parsed context defining dependencies of code snippets of the source code under development, the code suggestion system processing the parsed context to determine corresponding databases comprising additional code objects associated to code objects of the source code under development identified by the dependencies of the source code, the code suggestion system retrieving, from the corresponding databases, the additional code objects associated to code objects of the source code under development, the code suggestion system generating a prompt using a portion of the additional code objects, the prompt being formatted for minimizing a prompt size, and the code suggestion system providing the prompt to a large language model to generate a response comprising a suggested code for completing the source code under development.

2. The computer-implemented system of claim 1, wherein the code suggestion system parses the context to generate a parsed context by applying contextual understanding to determine to determine a prefix and a suffix based on the context to query for a middle section to be filled.

3. The computer-implemented system of claim 1, wherein the code suggestion system parses the context to generate a parsed context by:
performing incremental parsing to reject a first portion of the code snippets comprising syntactically incorrect source code and to extract a second portion of the code snippets comprising syntactically correct source code; and
extracting a portion of the context corresponding to the second portion of the code snippets comprising syntactically correct source code.

4. The computer-implemented system of claim 1, wherein the code suggestion system parses the context to generate a parsed context to perform fill-in-the-middle tasks to fill in gaps between code snippets.

5. The computer-implemented system of claim 1, wherein the code suggestion system parses the context to generate a parsed context by:
determining a surrounding context of the source code within a source code development environment and dependencies influencing operations of the source code.

6. The computer-implemented system of claim 1, wherein the code suggestion system retrieves, from the corresponding databases, the additional code objects associated to code objects of the source code under development by performing a plurality of retrieval operations for cascades of code object dependencies.

7. The computer-implemented system of claim 1, wherein the additional code objects comprise inheritance related objects or interface related objects, compiler related objects, or externally defined object types, domain related objects.

8. The computer-implemented system of claim 1, wherein the prompt is being formatted according to a large language model type.

9. A computer-implemented method, comprising:
receiving, via an application programming interface from a local development environment, a request to complete a source code under development, the request including a context of the source code;
parsing the context to generate a parsed context defining dependencies of code snippets of the source code under development;
processing the parsed context to determine corresponding databases comprising additional code objects associated to code objects of the source code under development identified by the dependencies of the source code;
retrieving, from the corresponding databases, the additional code objects associated to code objects of the source code under development;
generating a prompt using a portion of the additional code objects, the prompt being formatted for minimizing a prompt size; and
providing the prompt to a large language model to generate a response comprising a suggested code for completing the source code under development.

10. The computer-implemented method of claim 9, wherein parsing the context comprises applying contextual understanding to determine to determine a prefix and a suffix based on the context to query for a middle section to be filled.

11. The computer-implemented method of claim 9, wherein parsing the context comprises:
performing incremental parsing to reject a first portion of the code snippets comprising syntactically incorrect source code and to extract a second portion of the code snippets comprising syntactically correct source code; and
extracting a portion of the context corresponding to the second portion of the code snippets comprising syntactically correct source code.

12. The computer-implemented method of claim 9, wherein parsing the context comprises generating a parsed context to perform fill-in-the-middle tasks to fill in gaps between code snippets.

13. The computer-implemented method of claim 9, wherein parsing the context comprises:
determining a surrounding context of the source code within a source code development environment and dependencies influencing operations of the source code.

14. The computer-implemented method of claim 9, wherein retrieving, from the corresponding databases, the additional code objects comprises performing a plurality of retrieval operations for cascades of code object dependencies.

15. The computer-implemented method of claim 9, wherein the additional code objects comprise inheritance related objects or interface related objects, compiler related objects, or externally defined object types, domain related objects.

16. The computer-implemented method of claim 9, wherein the prompt is being formatted according to a large language model type.

17. A non-transitory computer-readable media encoded with a computer program, the computer program comprising instructions that when executed by one or more computers cause the one or more computers to perform operations comprising:
receiving, via an application programming interface from a local development environment, a request to complete a source code under development, the request including a context of the source code;
parsing the context to generate a parsed context defining dependencies of code snippets of the source code under development;
processing the parsed context to determine corresponding databases comprising additional code objects associated to code objects of the source code under development identified by the dependencies of the source code;
retrieving, from the corresponding databases, the additional code objects associated to code objects of the source code under development;
generating a prompt using a portion of the additional code objects, the prompt being formatted for minimizing a prompt size; and
providing the prompt to a large language model to generate a response comprising a suggested code for completing the source code under development.

18. The non-transitory computer-readable media of claim 17, wherein parsing the context comprises applying contextual understanding to determine to determine a prefix and a suffix based on the context to query for a middle section to be filled.

19. The non-transitory computer-readable media of claim 17, wherein parsing the context comprises:
performing incremental parsing to reject a first portion of the code snippets comprising syntactically incorrect source code and to extract a second portion of the code snippets comprising syntactically correct source code; and
extracting a portion of the context corresponding to the second portion of the code snippets comprising syntactically correct source code.

20. The non-transitory computer-readable media of claim 17, wherein parsing the context comprises generating a parsed context to perform fill-in-the-middle tasks to fill in gaps between code snippets.
